(19) United States
(12) Patent Application Publication
(10) Pub. No.: US 2026/0276476 A1
(43) Pub. Date: Sep. 17, 2026

(54) METHOD AND SYSTEM FOR ASSESSING STRUCTURAL INTEGRITY OF STREET LIGHTING LUMINAIRES

(71) Applicant: SIGNIFY HOLDING B.V., EINDHOVEN (NL)

(72) Inventors: JIN YU, LEXINGTON, MA (US); PETER DEIXLER, ARLINGTON, MA (US); KATIE MONROE, BURLINGTON, MA (US); YINGNAN LIU, NEWTON, MA (US)

(21) Appl. No.: 19/473,421

(22) PCT Filed: Mar. 26, 2024
(86) PCT No.: PCT/EP2024/058021

§ 371 Date: Oct. 7, 2025

Related U.S. Application Data
(60) Provisional application No. 63/457,916, filed on Apr. 7, 2023.

(30) Foreign Application Priority Data
Apr. 18, 2023 (EP) 23168374.9

(51) Int. Cl. G01M 5/00

(52) U.S. Cl. CPC G01M 5/0066; G01M 5/0025

(57) ABSTRACT

A method (100) and system (500) for assessing structural integrity of street lighting luminaires are provided. The method comprises determining (110) first vibration data, yⱼ(t), at a street lighting luminaire, j, as a function, ƒⱼ, of at least one of speed, s₀, of a passing vehicle, and distance, d₀, between the vehicle and the street lighting luminaire, j, given at least one property, rₖ, of the street. The method further comprises determining (120) second vibration data, y^{l}ⱼ(t), at at least one neighboring street lighting luminaire, l. The method further comprises normalizing (130) and comparing (140) the first and second vibration data, yⱼ(t), y^{l}ⱼ(t). In case of a difference, Δ, between the normalized first and second vibration data, yⱼ(t)ₙ, y^{l}ⱼ(t)ₙ, exceeds a threshold, T_{d}, the method registers (150) an anomaly count, A_{c}, for the street lighting luminaire, j, and assesses (160) the structural integrity thereof, based on the anomaly count, A_{c}.

### FIELD OF THE INVENTION

The present invention generally relates to the field of structural integrity of street lighting luminaires. More specifically, the present invention relates to the assessment of the structural integrity of street lighting luminaires and/or the detection of structural integrity issues thereof.

### BACKGROUND OF THE INVENTION

For street lighting luminaires, there are well-known safety issues related to impairment of the luminaires such as damages and/or cracks in the mounting bracket. For example, in case of severe impairment, a luminaire may even fall from the streetlight pole, which may have serious consequences. The issues carry high liability due to an imminent danger for pedestrians and/or traffic passing such a street lighting luminaire.

There are currently options for attempting to detect structural issues of street lighting luminaires, such as (manual) monitoring methods and/or electronic monitoring of the occurrence of cracks. However, it has shown that suggested monitoring methods of this kind are complex and/or inefficient with regard to cost and/or time.

Hence, alternative solutions are of interest, which are able to (cost-) efficiently and conveniently assess the structural integrity of street lighting luminaires. In other words, it is desirable to assess and/or detect impairment or damage of street lighting luminaire in a convenient manner which furthermore is time and/or cost efficient.

### SUMMARY OF THE INVENTION

It is an object of the present invention to mitigate the above problems and to provide methods and systems for assessing the structural integrity of street lighting luminaires and/or detect impairment or damage of these in a convenient manner which furthermore is time and/or cost efficient.

This and other objects are achieved by providing a method and a system having the features in the independent claims. Preferred embodiments are defined in the dependent claims.

Hence, according to a first aspect of the present invention, there is provided a method for assessing structural integrity of street lighting luminaires. The method comprises, for each street lighting luminaire, j, of a plurality of street lighting luminaires, j=1, . . . , k, arranged adjacent a street, and iteratively for a vehicle, of a plurality of vehicles, moving on the street, determining first vibration data, yⱼ(t), as a function of time, t, at the street lighting luminaire, j, as a function, ƒⱼ, of at least one of speed, s₀, of the vehicle, and distance, d₀, between the vehicle and the street lighting luminaire, j, given at least one property, rₖ, of the street. The method further comprises determining second vibration data, y^{l}ⱼ(t), as a function of time, t, at at least one neighboring street lighting luminaire, l, of the street lighting luminaire, j. The method further comprises normalizing the first vibration data, yⱼ(t), and the second vibration data, y^{l}ⱼ(t), respectively, with respect to at least one of the speed, s₀, of the vehicle, and the distance, d₀, between the vehicle and the respective street lighting luminaire, j, l, to normalized first vibration data, yⱼ(t)ₙ, and normalized second vibration data, y^{l}ⱼ(t)ₙ, respectively. The method further comprises comparing the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the method comprises registering an anomaly count, A_{c}, for the street lighting luminaire, j, and assessing structural integrity of the street lighting luminaire, j, based on the anomaly count, A_{c}.

According to a second aspect of the present invention, there is provided a system for assessing structural integrity of street lighting luminaires. The system comprises a processor configured to obtain, for each street lighting luminaire, j, of a plurality of street lighting luminaires, j=1, . . . , k, arranged adjacent a street, and iteratively for a vehicle, of a plurality of vehicles, moving on the street, first vibration data, yⱼ(t), as a function of time, t, at the street lighting luminaire, j, as a function, ƒⱼ, of at least one of speed, s₀, of the vehicle, and distance, d₀, between the vehicle and the street lighting luminaire, j, given at least one property, rₖ, of the street. The processor is further configured to determine second vibration data, y^{l}ⱼ(t), as a function of time, t, at at least one neighboring street lighting luminaire, l, of the street lighting luminaire, j. The processor is further configured to normalize the first vibration data, yⱼ(t), and the second vibration data, y^{l}ⱼ(t), respectively, with respect to at least one of the speed, s₀, of the vehicle, and the distance, d₀, between the vehicle and the respective street lighting luminaire, j, l, to normalized first vibration data, yⱼ(t)ₙ, and normalized second vibration data, y^{l}ⱼ(t)ₙ, respectively. The processor is further configured to compare the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, the system is configured to register an anomaly count, A_{c}, for the street lighting luminaire, j, and assess structural integrity of the street lighting luminaire, j, based on the anomaly count, A_{c}.

Thus, the present invention according to the first aspect is based on the idea of assessing structural integrity of street lighting luminaires by determining (first) vibration data, yⱼ(t), as a function of time, and vehicle speed, s₀, and/or distance, d₀, between the vehicle and the street lighting luminaire, j, given at least one property, rₖ, of the street. Since neighboring street lighting luminaires, l, are arranged at (along) the same street, it is assumed that the same or similar property(ies), rₖ, of the street, prevail(s). By comparing the normalized first vibration data, yⱼ(t)ₙ, of a street lighting luminaire, j, with the normalized second vibration data, y^{l}ⱼ(t)ₙ, of its neighboring street light luminaire(s), vibration anomaly(ies) may be detected for the street lighting luminaire, j, consequently indicating structural integrity issues, such as mounting bracket issues, of the street lighting luminaire, j. In other words, the street lighting luminaires may vibrate differently with parameters such as vehicle speed, s₀, and/or distance, d₀, between the vehicle and the street lighting luminaire, j, and by comparing the vibrations of a street lighting luminaire, j, with that of one or more neighboring street lighting luminaires, l, structural integrity issues of the street lighting luminaire, j, may be detected.

The present invention is advantageous in that the method of assessing the structural integrity of street lighting luminaires by the described vibration measurement may provide a high degree of efficiency and/or accuracy. By the detection of abnormal vibration data of a street lighting luminaire, j, via comparison of neighboring street lighting luminaire(s), l, the efficiency and/or accuracy of the assessment of structural issues such as cracks, loose component(s), etc., of street lighting luminaires, is improved compared to prior art techniques.

The present invention is advantageous in that the method of assessing the structural integrity of street lighting luminaires by measuring vibrations at these street lighting luminaires is efficient with respect to cost and/or time. It will be appreciated that (manual) monitoring methods and/or electronic monitoring of the structural integrity of street lighting luminaire may be cost and/or time inefficient. In contrast, the vibration-dependent measurement method of the present invention provides efficiency in that any manual monitoring and/or assessment, or electronic monitoring, may be dispensed with, thereby saving time and/or cost.

The present invention is advantageous in that the method of assessing the structural integrity of street lighting luminaires based on vibration measurement at the street lighting luminaires provides a higher extent of safety compared to other prior art methods.

For example, in case of manual assessment, persons present at the street lighting luminaires may be subjected to the risk(s) of traffic, both regarding toxic exhausts as well as traffic accidents. By the present invention, on the other hand, assessment of structural integrity of street lighting luminaires may be automatic, and the present invention thereby constitutes a safe assessment operation. In addition, rather than assessing the structural integrity only occasionally (e.g. once every five years), the present invention can assess the structural integrity on a continuous basis. This enables observations of a gradual increase in the time series vibration data of the luminaire over time (e.g. over a time period of 9 months) which is a proxy for the time series progression of the crack over time from a initially small damage of the luminaire (e.g. crack) to a relatively large, safety-critical luminaire damage (crack). If strong vibrations occur suddenly, this may be indicative a different type of structural integrity issue (e.g. that the luminaire has been hit by an object, vehicle, or the like) rather than a gradual increase in the degree of vibration (e.g. a crack in the mounting bracket due to a mechanical weakness).

It will be appreciated that the mentioned advantages of the method of the first aspect of the present invention also hold for the system according to the second aspect of the present invention.

According to the first aspect of the present invention, there is provided a method for assessing structural integrity of street lighting luminaires. By “structural integrity”, it is here meant the structural state, structural condition, or the like. By “street lighting luminaires”, it is here meant streetlights, light poles, or the like. The method comprises, for each street lighting luminaire, j, of a plurality of street lighting luminaires, j=1, . . . , k, arranged adjacent a street, and iteratively for a vehicle, of a plurality of vehicles, moving on the street, determining first vibration data, yⱼ(t), as a function of time, t, at the street lighting luminaire, j. Hence, the first vibration data, yⱼ(t), as a function of time, t, at the street lighting luminaire, j, is determined by the passing of (single) vehicles on the street. By the term “street”, it is here meant a street, road, highway, or the like. By the term “vehicle”, it is here meant primarily a car, truck, lorry, bus, or the like. The first vibration data, yⱼ(t), is determined as a function, ƒⱼ, of at least one of speed, s₀, of the vehicle, and distance, d₀, between the vehicle and the street lighting luminaire, j, given at least one property, rₖ, of the street. Hence, the vibration data, yⱼ(t), is determined (e.g. measured and/or estimated) as a function, ƒⱼ, of vehicle speed, s₀, of the vehicle and/or distance, d₀, between the vehicle and the street lighting luminaire, j, given at least one property, rₖ, of the street. By the term “distance, d₀, between the vehicle and the street lighting luminaire, j”, it may here be meant the horizontal distance between the vehicle and the street lighting luminaire, j, or the distance between the vehicle and any part or portion of the street lighting luminaire, j. By the term “property of the street”, it is here meant a condition, quality, state, bridge structure, road surface on solid ground or the like, of the street. The method further comprises determining second vibration data, y^{l}ⱼ(t), as a function of time, t, at at least one neighboring street lighting luminaire, l, of the street lighting luminaire, j. By “neighboring street lighting luminaire, l, of the street lighting luminaire, j,”, it is here meant substantially any neighboring street lighting luminaire, l, of the street lighting luminaire, j, such as e.g. the 3-10 (closest) neighboring street lighting luminaires, l, of the street lighting luminaire, j. The method further comprises normalizing the first vibration data, yⱼ(t), and the second vibration data, y^{l}ⱼ(t), respectively, with respect to at least one of the speed, s₀, of the vehicle, and the distance, d₀, between the vehicle and the respective street lighting luminaire, j, l, to normalized first vibration data, yⱼ(t)ₙ, and normalized second vibration data, y^{l}ⱼ(t)ₙ, respectively. Hence, the method comprises normalizing the first and second vibration data, yⱼ(t), y^{l}ⱼ(t), respectively, with respect to the vehicle speed, s₀, and/or the distance, d₀, between the vehicle and the respective street lighting luminaire, j, l, to normalized first and second vibration data, yⱼ(t)ₙ, y^{l}ⱼ(t)ₙ, respectively.

The method further comprises comparing the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the method comprises registering an anomaly count, A_{c}, for the street lighting luminaire, j, and assessing structural integrity of the street lighting luminaire, j, based on the anomaly count, A_{c}. Hence, in case of (a) difference(s), Δ, between the normalized first and second vibration data, yⱼ(t)ₙ, y^{l}ⱼ(t)ₙ, for the street lighting luminaire, j, exceeding the threshold(s), T_{d}, the method registers an anomaly count, A_{c}, for the street lighting luminaire, j, and assesses structural integrity of the street lighting luminaire, j, based on the anomaly count, A_{c}. In other words, in case of (a) relatively large difference(s) between the normalized first and second vibration data, yⱼ(t)ₙ, y^{l}ⱼ(t)ₙ, of the street lighting luminaire, j, the method registers an anomaly for the structural integrity of the street lighting luminaire, j, and assesses structural integrity of the street lighting luminaire, j, accordingly.

According to an embodiment of the present invention, the method may further comprise determining the first vibration data, yⱼ(t), as a function of time, t, at the street lighting luminaire, j, as a function, ƒⱼ, of weight, w₀, of the vehicle. The method may further comprise normalizing the first vibration data, yⱼ(t), and the second vibration data, y^{l}ⱼ(t), respectively, with respect to the weight, w₀, of the vehicle. It will be appreciated that the vehicle weight, w₀, may be measured, sensed, obtained as an input, etc. The weight may for instance be inferred based on a microphone sensor classifying the vehicle as a heavy vehicle, such as an 18-wheeler truck. It will be appreciated that the weight, w₀, of the vehicle may significantly affect the vibration data. The present embodiment is thereby advantageous in that the first vibration data, yⱼ(t), and the second vibration data, y^{l}ⱼ(t), may be determined even more accurately, leading to an even more accurate assessment of structural integrity of the street lighting luminaires.

According to an embodiment of the present invention, the method may further comprise determining at least one subset, Sᵢ, of the at least one neighboring street lighting luminaire, l, of the street lighting luminaire, j, based on at least one criterion, Cᵢ. The method may further comprise determining the second vibration data, y^{l}ⱼ(t), as a function of time, t, at the at least one subset, Sᵢ, of the at least one neighboring street lighting luminaire, l, of the street lighting luminaire, j. Hence, the method may determine subset(s), Sᵢ, of the neighboring street lighting luminaire(s), l, of the street lighting luminaire, j, based on criterion(s), Cᵢ, and determine the second vibration data, y^{l}ⱼ(t), at the subset(s), Sᵢ, of the neighboring street lighting luminaire(s), l, of the street lighting luminaire, j. The at least one criterion, Cᵢ, may constitute substantially any kind of criterion(s) associated with the street lighting luminaire(s), pole height, pole type, vehicle data, etc. The present embodiment is advantageous in that the method may efficiently determine or select the neighboring street lighting luminaire, l, of the street lighting luminaire, j, for the structural integrity assessment, subsequently leading to an even more accurate assessment, estimation and/or determination of the structural integrity of the street lighting luminaire, j.

According to an embodiment of the present invention, the at least one criterion, Cᵢ, may comprise at least one of at least one difference, Δ, of the at least one property, rₖ, of the street, at the at least one street lighting luminaire, l, of the at least one subset, Sᵢ, of the at least one neighboring street lighting luminaire, l, of the street lighting luminaire, j, being within a threshold, Tₚ, and at least one difference, Δ, of the weight, w₀, of the vehicle, determined at the at least one street lighting luminaire, l, of the at least one subset, Sᵢ, of the at least one neighboring street lighting luminaire, l, of the street lighting luminaire, j, being within a threshold, T_{w}. Hence, the criterion(s), Cᵢ, may comprise difference(s), Δ, of the property(ies), rₖ, of the street, at the street lighting luminaire(s), l, of the subset(s), Sᵢ, of the neighboring street lighting luminaire(s), l, of the street lighting luminaire, j, being within a threshold, Tₚ. For example, in case of a property, rₖ, (condition) of the street, such as street quality, pavement type (concrete, asphalt, marble, steel plates, gravel, etc.), being within the threshold, Tₚ, the method 100 may determine a subset, Sᵢ, of one or more neighboring street lighting luminaire, l, of the street lighting luminaire, j, based on this criterion, Cᵢ. Hence, the method 100 determines or estimates that the property/condition, rₖ, of the street, is the same or similar for the one or more neighboring street lighting luminaire, l, of the street lighting luminaire, j, and determines the second vibration data, y^{l}ⱼ(t), as a function of time, t, at the subset, Sᵢ, of the neighboring street lighting luminaire(s), l, of the street lighting luminaire, j. The present embodiment is advantageous in that the estimated vibration property(ies) of the subset, Sᵢ, of neighboring street lighting luminaire(s), l, based on the criterion(s), Cᵢ, let(s) the method 100 even more distinctly detect (abnormal) first vibration data, yⱼ(t), compared to the second vibration data, y^{l}ⱼ(t), which consequently improved the detection, estimation and/or determination of (possible) structural integrity issues of the street lighting luminaire, j.

According to an embodiment of the present invention, the method may further comprise, in case the anomaly count, A_{c}, exceeds at least one threshold, Tₓ, determining a structural integrity issue of the street lighting luminaire, j. Hence, in case of a relatively large anomaly count, A_{c}, or number, exceeding the threshold(s), Tₓ, the method may determine or estimate a structural integrity issue (defect) of the street lighting luminaire, j. The present embodiment is advantageous in that the method may conveniently and efficiently determine a structural integrity issue of the street lighting luminaire, j, based on the anomaly count, A_{c}, and threshold(s), Tₓ.

According to an embodiment of the present invention, the method may further comprise reporting the structural integrity issue of the street lighting luminaire, j, to a service unit. Hence, in case the method determines a structural integrity issue of the street lighting luminaire, j, the issue may be reported to a service unit. By “service unit” it is here meant a unit with the purpose of mending and/or repairing street lighting luminaires upon receiving structural integrity issue reports. The present embodiment is advantageous in that the method may conveniently and efficiently report any determined or estimated damage(s) and/or issues with the street lighting luminaire, j, to the service unit.

According to an embodiment of the present invention, the method may further comprise obtaining the function, ƒⱼ, by applying a machine-learning algorithm to a training data set comprising the at least one property, rₖ, of the street, and at least one of the speed, s₀, of the vehicle, the distance, d₀, between the vehicle and the street lighting luminaire, j, and weight, w₀, of the vehicle. Hence, via a training data set comprising, firstly, the property, Ik, of the street, and secondly, the speed, s₀, of the vehicle, the distance, d₀, between the vehicle and the street lighting luminaire, j, and/or weight, w₀, of the vehicle, the machine learning algorithm may provide the function, ƒⱼ, representing the first vibration data, yⱼ(t). By “machine-learning algorithm” it is here meant substantially any algorithm and/or method applicable to training data set via machine learning, as known by the skilled person. Hence, the first vibration data, yⱼ(t), as a function of time, t, at the street lighting luminaire, j, may be represented by the function, ƒⱼ, as determined or established by the machine-learning algorithm by the input of training data comprising one or more properties of the street, rₖ, and one or more of the speed, s₀, of the vehicle, the distance, d₀, between the vehicle and the street lighting luminaire, j, and weight, w₀, of the vehicle. The present embodiment is advantageous in that the function, ƒⱼ, may be conveniently and efficiently determined or established by the machine learning algorithm.

According to an example of the present invention, the method may further comprise assessing structural integrity of the street lighting luminaire, j, periodically. Hence, the method may comprise a periodical assessment of the structural integrity of the street lighting luminaire, j. For example, the period may be set to a relatively long time, such as e.g. 1-5 years, or a relatively short (or even very short) period, such that the assessment is performed on a continuous basis. The present example is advantageous in that this enables observations of a gradual increase in the time series vibration data of the luminaire over time which is a proxy for the time series progression of the crack over time from a initially small damage of the luminaire (e.g. crack) to a relatively large, safety-critical luminaire damage (crack). If strong vibrations occur suddenly, this may be indicative a different type of structural integrity issue (e.g. that the luminaire has been hit by an object, vehicle, or the like) rather than a gradual increase in the degree of vibration (e.g. a crack in the mounting bracket due to a mechanical weakness).

According to an embodiment of the second aspect of the present invention, the processor is configured to obtain first vibration data, yⱼ(t), as a function of time, t, at the street lighting luminaire, j, as a function, ƒⱼ, of weight, w₀, of the vehicle. The processor is further configured to normalize the first vibration data, yⱼ(t), and the second vibration data, y^{l}ⱼ(t), respectively, with respect to the weight, w₀, of the vehicle.

According to an embodiment of the second aspect of the present invention, the processor is configured to determine at least one subset, Sᵢ, of the at least one neighboring street lighting luminaire, l, of the street lighting luminaire, j, based on at least one criterion, Cᵢ. The processor is further configured to determine the second vibration data, y^{l}ⱼ(t), as a function of time, t, at the at least one subset, Sᵢ, of the at least one neighboring street lighting luminaire, l, of the street lighting luminaire, j.

According to an embodiment of the second aspect of the present invention, the at least one criterion, Cᵢ, comprises at least one of at least one difference, Δ, of the at least one property, rₖ, of the street, at the at least one street lighting luminaire, l, of the at least one subset, Sᵢ, of the at least one neighboring street lighting luminaire, l, of the street lighting luminaire, j, is within a threshold, Tₚ, and at least one difference, Δ, of the weight, w₀, of the vehicle, at the at least one street lighting luminaire, l, of the at least one subset, Sᵢ, of the at least one neighboring street lighting luminaire, l, of the street lighting luminaire, j, is within a threshold, T_{w}.

According to an embodiment of the second aspect of the present invention, in case the anomaly count, A_{c}, exceeds at least one threshold, Tₓ, the system is configured to determine a structural integrity issue of the street lighting luminaire, j.

According to an embodiment of the present invention, there is provided a street lighting arrangement for assessing structural integrity of street lighting luminaires, comprising a plurality of street lighting luminaires, j=1, . . . , k, arranged adjacent a street, wherein each street lighting luminaire of the plurality of street lighting luminaires comprises a respective sensor. Each sensor is configured to obtain, for each street lighting luminaire, j, of the plurality of street lighting luminaires, j=1, . . . , k, and iteratively for a vehicle, of a plurality of vehicles, moving on the street, first vibration signal data, ysⱼ(t), as a function of time, t, at the street lighting luminaire, j, speed, s₀, of the vehicle, and distance, d₀, between the vehicle and the street lighting luminaire, j. The street lighting arrangement further comprises the system according to the second aspect of the present invention, wherein the first vibration data, yⱼ(t) is based on the first vibration signal data, ysⱼ(t), the speed, s₀, of the vehicle, and the distance, d₀, between the vehicle and the street lighting luminaire, j.

According to an embodiment of the present invention, the processor of the street lighting arrangement is configured to determine the first vibration data, yⱼ(t), based on noise, nⱼ, generated by at least one of the respective sensor.

According to an embodiment of the present invention, the street lighting arrangement may further comprise at least one report unit. The system is configured to, in case the anomaly count, A_{c}, exceeds at least one threshold, T, determine a structural integrity issue of the street lighting luminaire, j, whereby the at least one report unit is arranged to report the structural integrity issue of the street lighting luminaire, j, to a service unit.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1-3 are schematic views of methods for assessing structural integrity of street lighting luminaires according to an exemplifying embodiment of the present invention,

FIG. 4 is a schematic view of a system according to an exemplifying embodiment of the present invention,

FIG. 5 is a schematic view of a street lighting arrangement according to an exemplifying embodiment of the present invention, and

FIG. 6 is a schematic view of a street lighting arrangement for assessing structural integrity of street lighting luminaires according to an exemplifying embodiment of the present invention.

### DETAILED DESCRIPTION

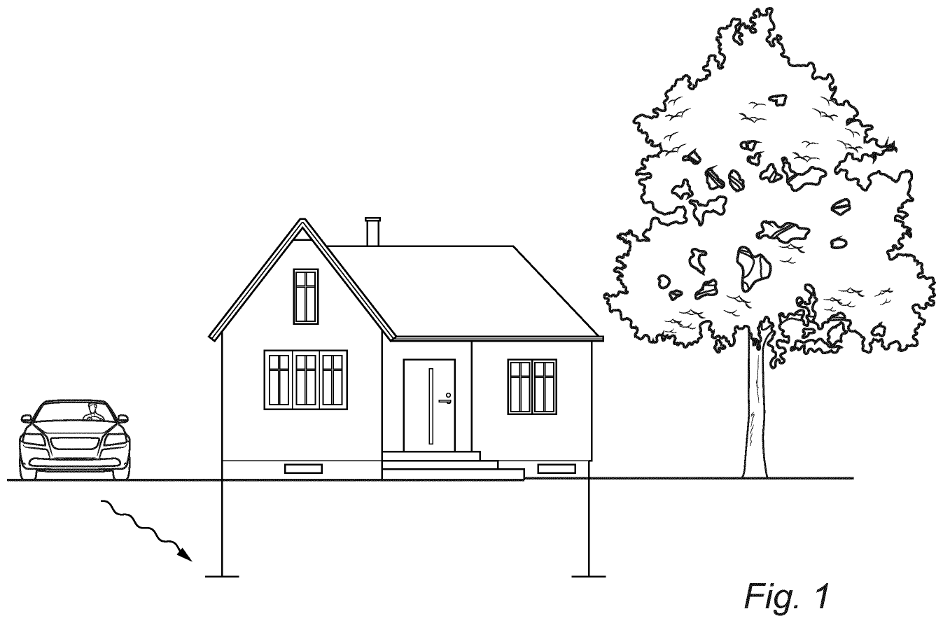

FIG. 1 shows a background example of a ground vibration scenario. Traffic induced ground vibrations are a frequent concern, and FIG. 1 illustrates an example of vehicle vibration force applied to a building foundation. In addition, narrow and damaged road sections (whereby residential buildings exist in the near vicinity and where vehicle access is not limited) are common in many cities. The vibrations can travel through the soil and can cause damage on infrastructure and buildings ranging from plaster crack to failure. Ground vibrations can also be a cause for people's annoyance. For instance, an overloaded truck entering a city can easily cause damage to streets, roads and/or bridges. However, the current state of the art professional ground-motion measuring devices require skilled personnel and are not easily available for a 24/7/365 continuous measurement and monitoring.

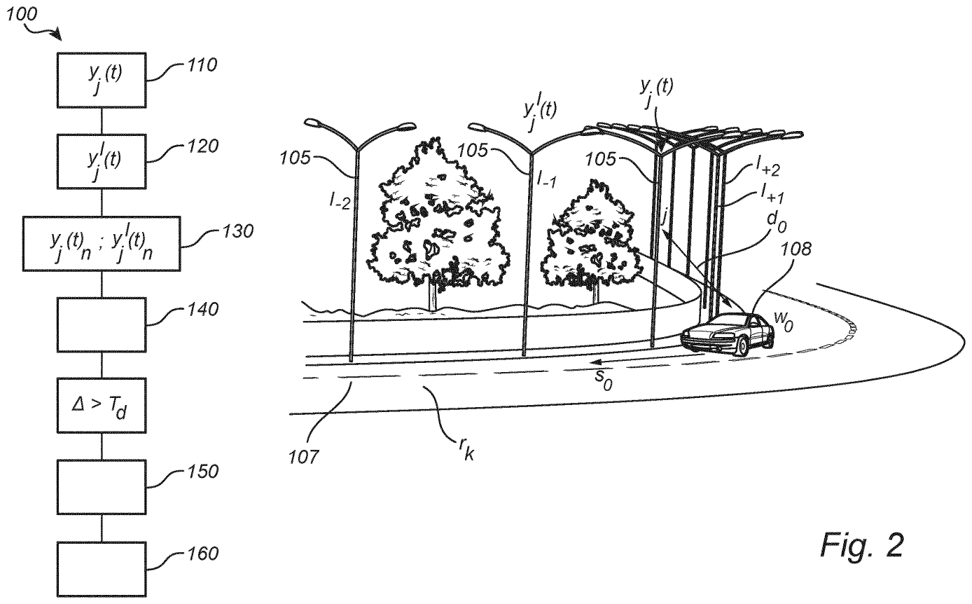

FIG. 2 is a schematic view of a method 100 for assessing structural integrity of street lighting luminaires 105 according to the first aspect of the present invention. The street lighting luminaires 105, as shown in FIG. 2, may be streetlights, light poles, or the like, for infrastructure illumination purposes. The number of street lighting luminaires 105 is arbitrary. The street lighting luminaires 105 are arranged adjacent a street 107, wherein the street 107 may be a road, a highway, etc., for vehicle traffic. Furthermore, it should be noted that the street 107 may run on a bridge, the street 107 may also run over a cavity covered by a metal plate, be provided with curves, etc. The method 100 comprises determining 110 first vibration data, yⱼ(t), for each street lighting luminaire, j, of a plurality of street lighting luminaires, j=1, . . . , k, iteratively for a vehicle 108, of a plurality of vehicles, moving on the street 107. Hence, the first vibration data, yⱼ(t), as a function of time, t, at the street lighting luminaire, j, is determined by the passing of a (single) vehicle 108, such as a car, truck, lorry, bus, or the like, on the street 107, as the passing vehicle(s) 108 generate vibrations.

For (at) each street lighting luminaire, j, the first vibration data, yⱼ(t), is determined (e.g. measured and/or estimated) by the method 100 as a function, ƒⱼ, of the speed, s₀, of the vehicle 108, and/or distance, d₀, between the vehicle 108 and the street lighting luminaire, j, given at least one property of the street, rₖ. It will be appreciated that the first vibration data, yⱼ(t), as determined by the method 100, may vary greatly between a relatively light and/or small vehicle 108 (such as a small/light car) compared to a relatively heavy and/or large vehicle 108 (such as a heavy/large) truck. The speed, s₀, of the vehicle 108, and/or the distance, d₀, between the vehicle 108 and the street lighting luminaire, j, may be provided as input to the method 100, or be measured and/or estimated. According to an example, the first vibration data, yⱼ(t), may furthermore be determined as a function of weight, w₀, of the vehicle 108.

The property(ies), rₖ, of the street 107 represent (a) condition(s), quality(ies), state(s), or the like, of the street 107. For example, in case of property(ies), rₖ, of the street 107, representing (and/or being associated with) a relatively low quality, such as e.g. street damage(s), hole(s), bumps, or the like, the vibration data, yⱼ(t), for the street lighting luminaire, j, may be higher (more amplified) compared to vibration data, yⱼ(t), for a vehicle 108 passing on a street 107 whereby the property(ies), rₖ, of the street 107, represent (and/or are associated with) a relatively high quality of the street 107.

The method 100 further comprises determining 120 second vibration data, y^{l}ⱼ(t), as a function of time, t, at one or more neighboring street lighting luminaires, l, of the street lighting luminaire, j. Hence, the second vibration data, y^{l}ⱼ(t), is determined 120 by the method 100 at one or more neighboring street lighting luminaire(s), l, of the street lighting luminaire, j. For example, the method 100 may determine 120 second vibration data, y^{l}ⱼ(t), at e.g. 1-10 neighboring street lighting luminaires, l, of the street lighting luminaire, j. For example, as shown in FIG. 1, there are two neighboring street lighting luminaires, l₋₁, l₋₂, on a first side of the street lighting luminaire, j, and two neighboring street lighting luminaires, l₊₁, l₊₂, on a second side of the street lighting luminaire, j. The method 100 further comprises normalizing 130 the first vibration data, yⱼ(t), and the second vibration data, y^{l}ⱼ(t), respectively, with respect to the speed, s₀, of the vehicle 108, and/or the distance, d₀, between the vehicle 108 and the respective street lighting luminaire(s), j, l, to normalized first vibration data, yⱼ(t)ₙ, and normalized second vibration data, y^{l}ⱼ(t)ₙ, respectively.

The method 100 further comprises comparing 140 the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the method 100 comprises registering 150 an anomaly count, A_{c}, for the street lighting luminaire, j, and assessing 160 structural integrity of the street lighting luminaire, j, based on the anomaly count, A_{c}. Hence, in case of (a) difference(s), Δ, between the normalized first and second vibration data, yⱼ(t)ₙ, y^{l}ⱼ(t)ₙ, for the street lighting luminaire, j, exceeds the threshold(s), T_{d} (e.g. based on a Gaussian 3σ rule), the method 100 registers 150 an anomaly count, A_{c}, for the street lighting luminaire, j, and assesses 160 structural integrity of the street lighting luminaire, j, based on the anomaly count, A_{c}. In other words, in case of (a) relatively large difference(s), Δ, between the normalized first and second vibration data, yⱼ(t)ₙ, y^{l}ⱼ(t)ₙ, of the street lighting luminaire, j, the method 100 registers 150 abnormal vibration properties (an abnormal vibration profile) of the street lighting luminaire, j, compared to its neighboring street lighting luminaires, l. Thus, an anomaly for the structural integrity of the street lighting luminaire, j, is registered by the method 100, and the method 100 assesses 160 structural integrity of the street lighting luminaire, j, accordingly. For example, in case the anomaly count, A_{c}, exceeds the threshold(s), T_{d}, during a time period (such as 1-3 months of monitoring), the method 100 may register 150 an anomaly for the structural integrity of the street lighting luminaire, j, and assesses 160 structural integrity of the street lighting luminaire, j, accordingly.

The method 100 may further comprise determining the first vibration data, yⱼ(t), as a function of time, t, at the street lighting luminaire, j, as a function, ƒⱼ, of weight, w₀, of the vehicle 108. The method 100 may further comprise normalizing the first vibration data, yⱼ(t), and the second vibration data, y^{l}ⱼ(t), respectively, with respect to the weight, w₀, of the vehicle 108. It will be appreciated that the vehicle 108 weight, w₀, may be measured, sensed, obtained as an input, etc.

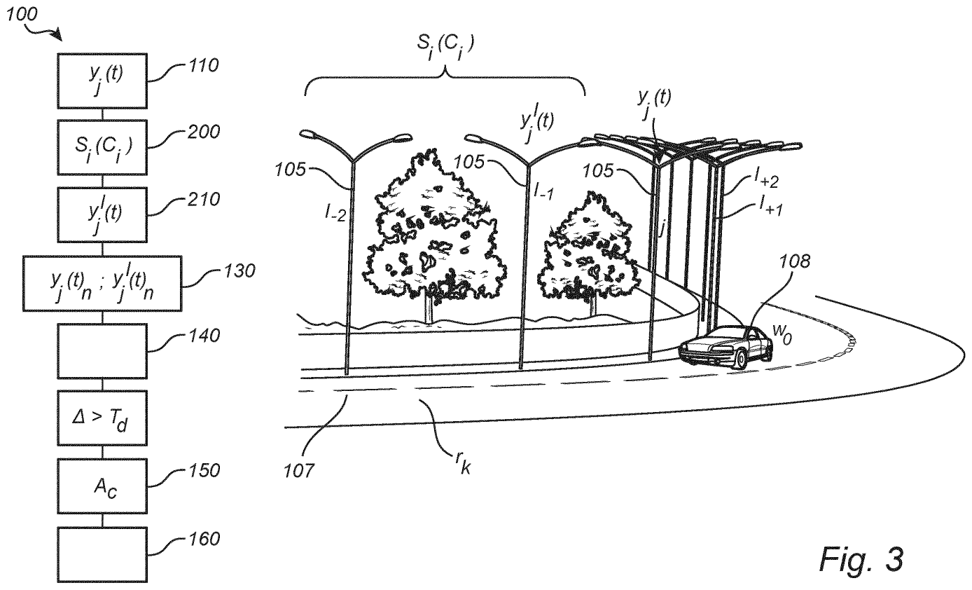

FIG. 3 is a schematic view of a method 100 for assessing structural integrity of street lighting luminaires 105 according to the first aspect of the present invention. It should be noted that the method 100 presented in FIG. 3 is based on the method 100 as disclosed in FIG. 3 and the associated text, and it is hereby referred to that figure and/or text for an increased understanding. According to FIG. 3, the method 100 further comprises determining at least one subset, Sᵢ, of the at least one neighboring street lighting luminaire, l, of the street lighting luminaire, j, based on at least one criterion, Cᵢ. Here, according to this example, the subset, Sᵢ, of neighboring street lighting luminaires, l, of the street lighting luminaire, j, comprises two street lighting luminaires, l₋₁, l₋₂, but it should be noted that the number is arbitrary. The at least one criterion, Cᵢ, may constitute substantially any kind of criterion(s) associated with the street lighting luminaire(s), vehicle 108 data, etc. For example, the criterion(s), Cᵢ, may comprise at least one difference, Δ, of the property(ies), rₖ, of the street, at the street lighting luminaire(s), l, of the subset, Sᵢ, being within a threshold, Tₚ. Hence, the criterion(s), Cᵢ, may encompass (a) relatively small difference(s), Δ, of the property(ies), rₖ, of the street, at (along) the street lighting luminaire(s), l, of the subset, Sᵢ. According to another example, the criterion(s), Cᵢ, may comprise difference(s), Δ, of the weight, w₀, of the vehicle 108, at the street lighting luminaire(s), l, of the subset, Sᵢ, being within a threshold, T_{w}. The method 100 further comprises determining 210 the second vibration data, y^{l}ⱼ(t), as a function of time, t, at the subset(s), Sᵢ, of the one or more neighboring street lighting luminaires, l, of the street lighting luminaire, j. Thereafter, in the following steps 140-160, the method 100 of FIG. 3 corresponds to the method of FIG. 2 and the associated text. Hence, the method comprises comparing 140 the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the method 100 comprises registering 150 an anomaly count, A_{c}, for the street lighting luminaire, j, and assessing 160 structural integrity of the street lighting luminaire, j, based on the anomaly count, A_{c}.

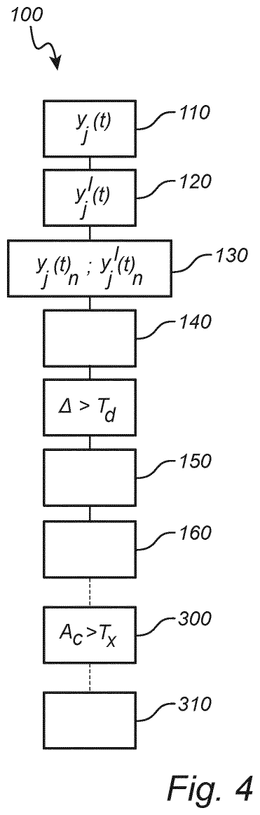

FIG. 4 is a schematic view of a method 100 for assessing structural integrity of street lighting luminaires 105 according to the first aspect of the present invention. It should be noted that the method 100 presented in FIG. 4 is based on the method(s) 100 as disclosed in FIG. 2 and/or FIG. 3 the associated text(s), and it is hereby referred to that (those) figures and/or text(s) for an increased understanding. In addition to the previously described methods, the method 100 of FIG. 3 comprises the additional steps of, in case the anomaly count, A_{c}, exceeds at least one threshold, Tₓ, determining 300 a structural integrity issue of the street lighting luminaire, j, and/or reporting 310 the structural integrity issue of the street lighting luminaire, j, to a service unit. Hence, in case of a relatively large anomaly count, A_{c}, or number, exceeding the threshold(s), Tₓ, the method 100 may determine 300 or estimate a structural integrity issue (defect) of the street lighting luminaire, j. Furthermore, in case the method 100 determines 300 the structural integrity issue of the street lighting luminaire, j, the issue may be reported 310 to a service unit.

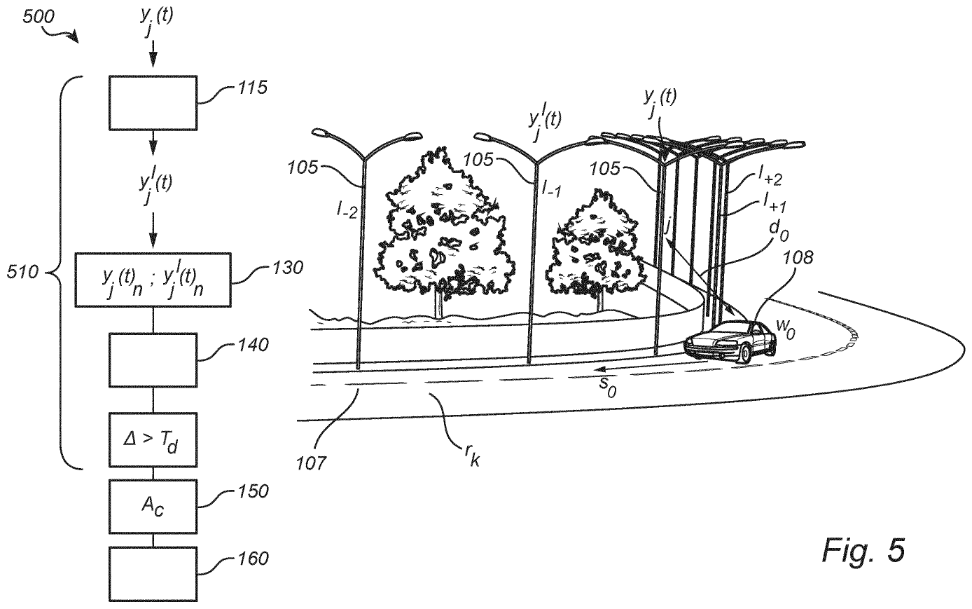

FIG. 5 is a schematic view of a system 500 for assessing structural integrity of street lighting luminaires 105 according to the second aspect of the present invention. The system 500 comprises a processor 510 configured to obtain 115, for each street lighting luminaire, j, of a plurality of street lighting luminaires, j=1, . . . , k, arranged adjacent a street 107, and iteratively for a vehicle 108, of a plurality of vehicles, moving on the street 107, first vibration data, yⱼ(t), as a function of time, t, at the street lighting luminaire, j, as a function, ƒⱼ, of at least one of speed, s₀, of the vehicle 108, and distance, d₀, between the vehicle 108 and the street lighting luminaire, j, given at least one property, rₖ, of the street 107. The processor 510 is further configured to determine second vibration data, y^{l}ⱼ(t), as a function of time, t, at at least one neighboring street lighting luminaire, l, of the street lighting luminaire, j. For example, as shown in FIG. 2, there are two neighboring street lighting luminaires, l₋₁, l₋₂, on a first side of the street lighting luminaire, j, and two neighboring street lighting luminaires, l₊₁, l₊₂, on a second side of the street lighting luminaire, j.

The processor 510 is further configured to normalize 130 the first vibration data, yⱼ(t), and the second vibration data, y^{l}ⱼ(t), respectively, with respect to at least one of the speed, s₀, of the vehicle 108, and the distance, d₀, between the vehicle 108 and the respective street lighting luminaire, j, l, to normalized first vibration data, yⱼ(t)ₙ, and normalized second vibration data, y^{l}ⱼ(t)ₙ, respectively. The processor 510 is further configured to compare the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the system 500 is configured to register 150 an anomaly count, A_{c}, for the street lighting luminaire, j, and assess 160 structural integrity of the street lighting luminaire, j, based on the anomaly count, A_{c}.

It should be noted that the system 500, via the processor 510, may be configured to perform further operations corresponding to the method 100 according to the first aspect of the present invention. For example, the processor 510 may be configured to obtain the first vibration data, yⱼ(t), as a function of time, t, at the street lighting luminaire, j, as a function, ƒⱼ, of weight, w₀, of the vehicle 108, and normalize the first vibration data, yⱼ(t), and the second vibration data, y^{l}ⱼ(t), respectively, with respect to the weight, w₀, of the vehicle 108. Furthermore, the processor 510 may be configured to determine at least one subset, Sᵢ, of the at least one neighboring street lighting luminaire, l, of the street lighting luminaire, j, based on at least one criterion, Cᵢ, and determine the second vibration data, y^{l}ⱼ(t), as a function of time, t, at the subset(s), Sᵢ, of the one or more neighboring street lighting luminaires, l, of the street lighting luminaire, j. Thereafter, the system 500 may be configured to compare 140 the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the system 500 may register 150 an anomaly count, A_{c}, for the street lighting luminaire, j, and assess 160 structural integrity of the street lighting luminaire, j, based on the anomaly count, A_{c}. Furthermore, as an example, the system 500 may be configured to, in case the anomaly count, A_{c}, exceeds at least one threshold, Tₓ, determine a structural integrity issue of the street lighting luminaire, j, and/or report the structural integrity issue of the street lighting luminaire, j, to a service unit.

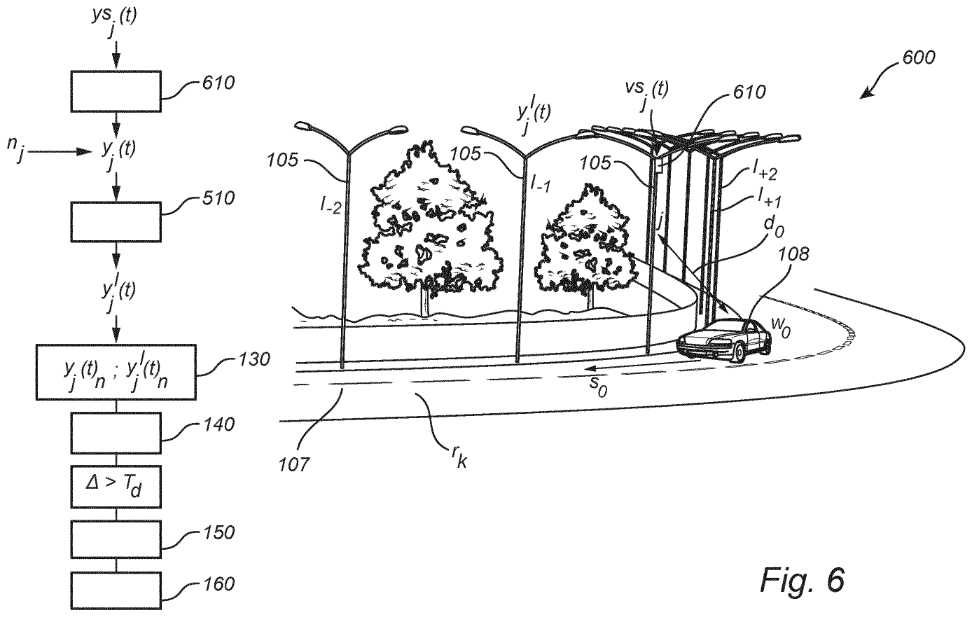

FIG. 6 is a schematic view of a street lighting arrangement 600 for assessing structural integrity of street lighting luminaires 105 according to an exemplifying embodiment of the present invention. The street lighting arrangement 600 comprises a plurality of street lighting luminaires, j=1, . . . , k, arranged adjacent a street 107, wherein each street lighting luminaire of the plurality of street lighting luminaires comprises a respective sensor 610. The sensor 610 may be a OSB (Outdoor Sensor Bundle), which may comprise radar, RF sensing, tilt, vibration, microphone and/or temperature sensors. It should be noted that the size, positioning, etc., of the sensor 610 in FIG. 6 is merely schematic. The sensor 610 is configured to obtain, for each street lighting luminaire, j, of the plurality of street lighting luminaires, j=1, . . . , k, and iteratively for a vehicle 108, of a plurality of vehicles, moving on the street 107, first vibration signal data, ysⱼ(t), as a function of time, t, at the street lighting luminaire, j, speed, s₀, of the vehicle, and distance, d₀, between the vehicle and the street lighting luminaire, j. The street lighting arrangement 600 further comprises the system according to the second aspect of the present invention, wherein the first vibration data, yⱼ(t) is based on the first vibration signal data, ysⱼ(t), the speed, s₀, of the vehicle, and the distance, d₀, between the vehicle and the street lighting luminaire, j. According to an example, the processor of the system may further be configured to determine the first vibration data, yⱼ(t), based on noise, nⱼ, generated by at least one of the respective sensor 610.

The system of the street lighting arrangement 600 may thereafter normalize 130 the first vibration data, yⱼ(t), and the second vibration data, y^{l}ⱼ(t), respectively, with respect to at least one of the speed, s₀, of the vehicle 108, and the distance, d₀, between the vehicle 108 and the respective street lighting luminaire, j, l, to normalized first vibration data, yⱼ(t)ₙ, and normalized second vibration data, y^{l}ⱼ(t)ₙ, respectively. Thereafter, the system of the street lighting arrangement 600 may be configured to compare 140 the normalized first vibration data, yⱼ(t)ₙ, with the normalized second vibration data, y^{l}ⱼ(t)ₙ. In case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ, the system may register 150 an anomaly count, A_{c}, for the street lighting luminaire, j, and assess 160 structural integrity of the street lighting luminaire, j, based on the anomaly count, A_{c}. Furthermore, as an example, the system may be configured to, in case the anomaly count, A_{c}, exceeds at least one threshold, Tₓ, determine a structural integrity issue of the street lighting luminaire, j, and/or report the structural integrity issue of the street lighting luminaire, j, to a service unit.

The person skilled in the art realizes that the present invention by no means is limited to the preferred embodiments described above. On the contrary, many modifications and variations are possible within the scope of the appended claims.

1. A method for assessing structural integrity of street lighting luminaires, comprising:
for each street lighting luminaire, j, of a plurality of street lighting luminaires, j=1, . . . , k, arranged adjacent a street, and iteratively for a vehicle, of a plurality of vehicles, moving on the street,
determining first vibration data, yⱼ(t), as a function of time, t, at the street lighting luminaire, j, as a function, ƒⱼ, of at least one of
speed, s₀, of the vehicle, and
distance, d₀, between the vehicle and the street lighting luminaire, j,
given at least one property, rₖ, of the street,
determining second vibration data, y^{l}ⱼ(t), as a function of time, t, at at least one neighboring street lighting luminaire, l, of the street lighting luminaire, j,
normalizing the first vibration data, yⱼ(t), and the second vibration data, y^{l}ⱼ(t), respectively, with respect to at least one of
the speed, s₀, of the vehicle, and
the distance, d₀, between the vehicle and the respective street lighting luminaire, j, l, to normalized first vibration data, yⱼ(t)ₙ, and normalized second vibration data, y^{l}ⱼ(t)ₙ, respectively,
comparing the normalized first vibration data, yⱼ(t)ₙ, with the normalized second vibration data, y^{l}ⱼ(t)ₙ,
in case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, Δ,
registering an anomaly count, A_{c}, for the street lighting luminaire, j, and
assessing structural integrity of the street lighting luminaire, j, based on the anomaly count, A_{c}.

2. The method according to claim 1, further comprising
determining the first vibration data, yⱼ(t), as a function of time, t, at the street lighting luminaire, j, as a function, ƒⱼ, of
weight, w₀, of the vehicle, and
normalizing the first vibration data, yⱼ(t), and the second vibration data, y^{l}ⱼ(t), respectively, with respect to
the weight, w₀, of the vehicle.

3. The method according to claim 1, further comprising:
determining at least one subset, Sᵢ, of the at least one neighboring street lighting luminaire, l, of the street lighting luminaire, j, based on at least one criterion, Cᵢ, and
determining the second vibration data, y^{l}ⱼ(t), as a function of time, t, at the at least one subset, Sᵢ, of the at least one neighboring street lighting luminaire, l, of the street lighting luminaire, j.

4. The method according to claim 2, wherein the at least one criterion, Cᵢ, comprises at least one of:
at least one difference, Δ, of the at least one property, rₖ, of the street, at the at least one street lighting luminaire, l, of the at least one subset, Sᵢ, of the at least one neighboring street lighting luminaire, l, of the street lighting luminaire, j, being within a threshold, Tₚ, and
at least one difference, Δ, of the weight, w₀, of the vehicle, determined at the at least one street lighting luminaire, l, of the at least one subset, Sᵢ, of the at least one neighboring street lighting luminaire, l, of the street lighting luminaire, j, being within a threshold, T_{w}.

5. The method according to claim 1, further comprising, in case the anomaly count, A_{c}, exceeds at least one threshold, Tₓ,
determining a structural integrity issue of the street lighting luminaire, j.

6. The method according to claim 5, further comprising:
reporting the structural integrity issue of the street lighting luminaire, j, to a service unit.

7. The method according to claim 1, further comprising:
obtaining the function, ƒⱼ, by applying a machine-learning algorithm to a training data set comprising
the at least one property, rₖ, of the street, and
at least one of
the speed, s₀, of the vehicle,
the distance, d₀, between the vehicle and the street lighting luminaire, j, and
weight, w₀, of the vehicle.

8. A system for assessing structural integrity of street lighting luminaires, comprising:
a processor configured to
obtain, for each street lighting luminaire, j, of a plurality of street lighting luminaires, j=1, . . . , k, arranged adjacent a street, and iteratively for a vehicle, of a plurality of vehicles, moving on the street,
first vibration data, yⱼ(t), as a function of time, t, at the street lighting luminaire, j, as a function, ƒⱼ, of at least one of
speed, s₀, of the vehicle, and
distance, d₀, between the vehicle and the street lighting luminaire, j, given at least one property, rₖ, of the street,
determine second vibration data, y^{l}ⱼ(t), as a function of time, t, at at least one neighboring street lighting luminaire, l, of the street lighting luminaire, j,
normalize the first vibration data, yⱼ(t), and the second vibration data, y^{l}ⱼ(t), respectively, with respect to at least one of:
the speed, s₀, of the vehicle, and
the distance, d₀, between the vehicle and the respective street lighting luminaire, j, l,
to normalized first vibration data, yⱼ(t)ₙ, and normalized second vibration data, y^{l}ⱼ(t)ₙ, respectively,
compare the normalized first vibration data, yⱼ(t)ₙ, with the normalized second vibration data, y^{l}ⱼ(t)ₙ,
wherein the system, in case of at least one difference, Δ, between the normalized first vibration data, yⱼ(t)ₙ, and the normalized second vibration data, y^{l}ⱼ(t)ₙ, for a street lighting luminaire, j, of the plurality of street lighting luminaires, exceeds at least one threshold, T_{d}, associated with the at least one difference, is configured to:
register an anomaly count, A_{c}, for the street lighting luminaire, j, and
assess structural integrity of the street lighting luminaire, j, based on the anomaly count, A_{c}.

9. The system according to claim 8, wherein the processor is configured to
obtain first vibration data, yⱼ(t), as a function of time, t, at the street lighting luminaire, j, as a function, ƒⱼ, of
weight, w₀, of the vehicle, and
normalize the first vibration data, yⱼ(t), and the second vibration data, y^{l}ⱼ(t), respectively, with respect to
the weight, w₀, of the vehicle.

10. The system according to claim 8, wherein the processor is configured to
determine at least one subset, Sᵢ, of the at least one neighboring street lighting luminaire, l, of the street lighting luminaire, j, based on at least one criterion, Cᵢ, and
determine the second vibration data, y^{l}ⱼ(t), as a function of time, t, at the at least one subset, Sᵢ, of the at least one neighboring street lighting luminaire, l, of the street lighting luminaire, j.

11. The system according to claim 9, wherein the at least one criterion, Cᵢ, comprises at least one of
at least one difference, Δ, of the at least one property, rₖ, of the street, at the at least one street lighting luminaire, l, of the at least one subset, Sᵢ, of the at least one neighboring street lighting luminaire, l, of the street lighting luminaire, j, is within a threshold, Tₚ, and
at least one difference Δ, of the weight, w₀, of the vehicle, at the at least one street lighting luminaire, l, of the at least one subset, Sᵢ, of the at least one neighboring street lighting luminaire, l, of the street lighting luminaire, j, is within a threshold, T_{w}.

12. The system according to claim 1, wherein, in case the anomaly count, A_{c}, exceeds at least one threshold, Tₓ, the system is configured to
determine a structural integrity issue of the street lighting luminaire, j.

13. A street lighting arrangement for assessing structural integrity of street lighting luminaires, comprising:
a plurality of street lighting luminaires, j=1, . . . , k, arranged adjacent a street, wherein each street lighting luminaire of the plurality of street lighting luminaires comprises a respective sensor,
wherein the sensor is configured to obtain,
for each street lighting luminaire, j, of the plurality of street lighting luminaires, j=1, . . . , k, and iteratively for a vehicle, of a plurality of vehicles, moving on the street,
first vibration signal data, ysⱼ(t), as a function of time, t, at the street lighting luminaire, j,
speed, s₀, of the vehicle, and
distance, d₀, between the vehicle and the street lighting luminaire, j, wherein the street lighting arrangement further comprises:
the system according to claim 8, wherein the first vibration data, yⱼ(t) is based on the first vibration signal data, ysⱼ(t), the speed, s₀, of the vehicle, and the distance, d₀, between the vehicle and the street lighting luminaire, j.

14. The street lighting arrangement according to claim 13, wherein the processor is configured to
determine the first vibration data, yⱼ(t), based on noise, nⱼ, generated by at least one of the respective sensor.

15. The street lighting arrangement according to claim 13, further comprising:
at least one report unit,
wherein the system is configured to, in case the anomaly count, A_{c}, exceeds at least one threshold, T, determine a structural integrity issue of the street lighting luminaire, j,
whereby the at least one report unit is arranged to report the structural integrity issue of the street lighting luminaire, j, to a service unit.
